(19) United States
(12) Patent Application Publication
(10) Pub. No.: US 2013/0338051 A1
(43) Pub. Date: Dec. 19, 2013

(54) METHOD FOR PRODUCING CHEMICALLY STRENGTHENED GLASS SUBSTRATE FOR DISPLAY DEVICE

(71) Applicant: ASAHI GLASS COMPANY, LIMITED, Chiyoda-ku (JP)

(72) Inventors: Shuji Matsumoto, Tokyo (JP); Tsuguhide Isemura, Tokyo (JP); Koji Nakagawa, Tokyo (JP); Kazutaka Ono, Tokyo (JP); Shusaku Akiba, Tokyo (JP); Haruo Aizawa, Tokyo (JP)

(73) Assignee: ASAHI GLASS COMPANY, LIMITED, Chiyoda-Ku (JP)

(21) Appl. No.: 13/908,451

(22) Filed: Jun. 3, 2013

Related U.S. Application Data
(63) Continuation of application No. PCT/JP2011/073738, filed on Oct. 14, 2011.

(30) Foreign Application Priority Data
Dec. 3, 2010 (JP) 2010-270395

(51) Int. Cl. C03C 23/00

(52) U.S. Cl. CPC C03C 23/0075
USPC 510/109

(57) ABSTRACT

The present invention provides a method for producing a chemically strengthened glass for a display device, which is capable of suppressing generation of concave defects. The present invention relates to a method for producing a chemically strengthened glass substrate for a display device, in which a calcium concentration in a cleaning liquid used in a final cleaning step before a chemical strengthening step is 5 ppm or less.

### TECHNICAL FIELD

The present invention relates to a method for producing a chemically strengthened glass substrate for a display device.

### BACKGROUND ART

A glass chemically strengthened by ion exchange or the like (hereinafter referred to as a “chemically strengthened glass”) is used in a cover glass of a display devices such as digital camera, mobile phone and PDA, and a glass substrate of a touch panel display. The chemically strengthened glass has high mechanical strength as compared with an unstrengthened glass, and is therefore suitable for those uses (Patent Documents 1 to 3).

The cover glass of a display device and the like and the glass substrate of a touch panel display are required to have high transparency, high smoothness and good appearance.

### PRIOR ART DOCUMENT

### Patent Document

Patent Document 1: JP-A-57-205343
Patent Document 2: JP-A-9-236792
Patent Document 3: JP-A-2009-84076

### SUMMARY OF THE INVENTION

### Problems that the Invention is to Solve

However, when a chemically strengthened glass substrate is used in a display device, a problem occurs in appearance in some cases. As a result of analyzing the glass substrate where the problem occurred in appearance by the present inventors, it has been found that very small concave defects (hereinafter referred to as “concave defects”) are generated on the surface of the glass substrate.

Accordingly, the present invention aims at providing a method for producing a chemically strengthened glass for a display device, the method being capable of suppressing generation of concave defects.

### Means for Solving the Problems

As a result of further investigations of the above problem, the present inventors have found that when a calcium salt is present on the surface of a glass that is to be subjected to a chemical strengthening step, calcium is fixed to the surface of the glass by passing through a drying step, and due to the fixed calcium, concave defects are generated by passing through a chemical strengthening step.

The present inventors have further found that when a calcium concentration in a cleaning liquid used in a final cleaning step before a chemical strengthening step is adjusted to a specific concentration or lower, the concave defects in a glass can be effectively suppressed even passing through a chemical strengthening step, and have completed the present invention.

Namely, the gist of the invention is as follows.
1. A method for producing a chemically strengthened glass substrate for a display device, wherein a calcium concentration in a cleaning liquid used in a final cleaning step before a chemical strengthening step is 5 ppm or less.
2. The method for producing a chemically strengthened glass substrate for a display device according to item 1 above, wherein the cleaning liquid is water.

### Advantage of the Invention

According to the production method of the present invention, a calcium concentration in a cleaning liquid used in a final cleaning step before a chemical strengthening step is adjusted to a specific concentration or lower. Consequently, a calcium salt is prevented from being present on the surface of a glass that is to be subjected to a chemical strengthening step, and generation of a layer in which calcium ions are diffused from the calcium salt can be prevented in a preheating step. This can suppress generation of the concave defects caused by the inhibition of ion exchange due to the calcium ion layer in an ion exchange step.

### BRIEF DESCRIPTION OF THE DRAWINGS

FIG. 1 is a view showing a mechanism of generation of a concave defect in a production process of a chemically strengthened glass.

FIG. 2 is a graph showing a correlation between a depth of concave defect and a calcium concentration in a solution that is brought into contact with a glass before a preheating step.

FIG. 3 is an analysis method of concave defects generated on a glass surface by conducting preheating and ion exchange treatment after dropwise addition of a solution containing calcium.

FIG. 4 is a view showing the result of texture image of concave defect generated on a glass substrate by conducting preheating and ion exchange treatment after dropwise addition of a solution containing calcium.

FIG. 5 is a view showing a depth and a width of concave defect generated on a glass substrate by conducting preheating and ion exchange treatment after dropwise addition of a solution containing calcium.

FIG. 6 is a view showing the result of texture image of concave defect generated on a glass substrate by conducting preheating and ion exchange treatment after dropwise addition of a solution containing calcium.

FIG. 7 is a view showing a depth and a width of concave defect generated on a glass substrate by conducting preheating and ion exchange treatment after dropwise addition of a solution containing calcium.

FIG. 8 is a view (magnification ratio of image: 150 times) showing content distribution of K₂O, Na₂O and CaO in a glass on the surface of concave defect generated on a glass surface by conducting preheating and ion exchange treatment after dropwise addition of a solution containing calcium.

### MODE FOR CARRYING OUT THE INVENTION

The present invention is described in detail below, but the invention is not limited thereto.

A method for producing a chemically strengthened glass substrate for a display device of the present invention ordinary includes a polishing step of polishing a glass, a cleaning step, a final cleaning step, a drying step and a chemical strengthening step sequentially. The chemical strengthening step includes an ion exchange step as an essential step, and in many cases, includes a preheating step before the ion exchange step.

### [Mechanism of Generation of Concave Defects]

The present inventors have found that the cause deteriorating appearance of a chemically strengthened glass substrate is a concave defect, and have found that the concave defects in a chemically strengthened glass substrate are caused by a calcium salt present on a glass surface before a preheating step. The cause that the calcium salt attaches to a glass surface includes (a) incorporation of calcium in an abrasive used in a polishing step, (b) incorporation of calcium in a cleaning liquid used in a cleaning step or a final cleaning step, and (c) attachment of calcium contained in sweat of human or incorporation thereof in a cleaning liquid, by touching with bare hands in a production process.

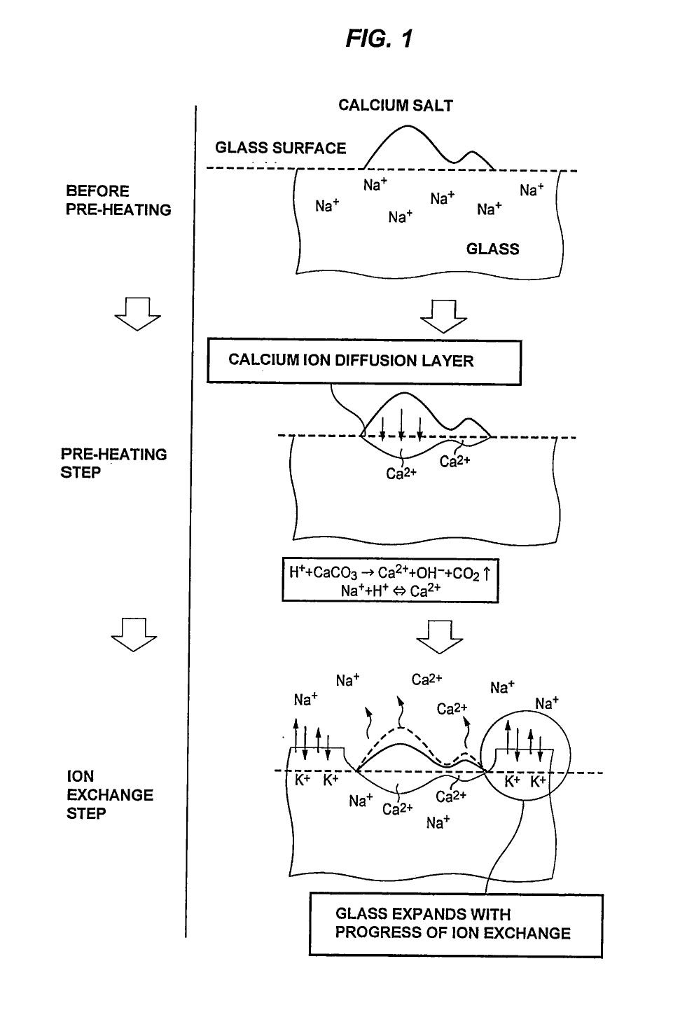

The mechanism of generation of concave defects in a production process of a chemically strengthened glass substrate found by the present inventors is as follows (FIG. 1). In FIG. 1, a case where a potassium nitrate molten salt is used as a molten salt used in an ion exchange step is explained as an example.

(1) Before preheating step: A calcium salt attaches to a glass surface before a preheating step, and fixes thereto by passing through a drying step. Examples of the calcium salt include CaCO₃, Ca(NO₃)₂ and CaSO₄.
(2) Preheating step: In a preheating step, a diffusion layer of calcium ions is generated from the calcium salt fixed to the glass surface. The diffusion layer of the calcium ions becomes a barrier material hindering ion exchange in the subsequent ion exchange step.
(3) Ion exchange step: In an ion exchange step, a glass expands by the substitution between sodium ions contained in a glass and potassium ions having an ionic radius larger than that of the sodium ions, contained in a molten salt. On the other hand, at a portion where a barrier material by the diffusion layer of calcium ions is formed, the calcium ions hinder ion exchange, whereby the diffusion layer of calcium ions becomes a barrier film of ion exchange, the glass does not expand, and depressions are generated to become defects.

### [Correlation Between Calcium Concentration and Concave Defect]

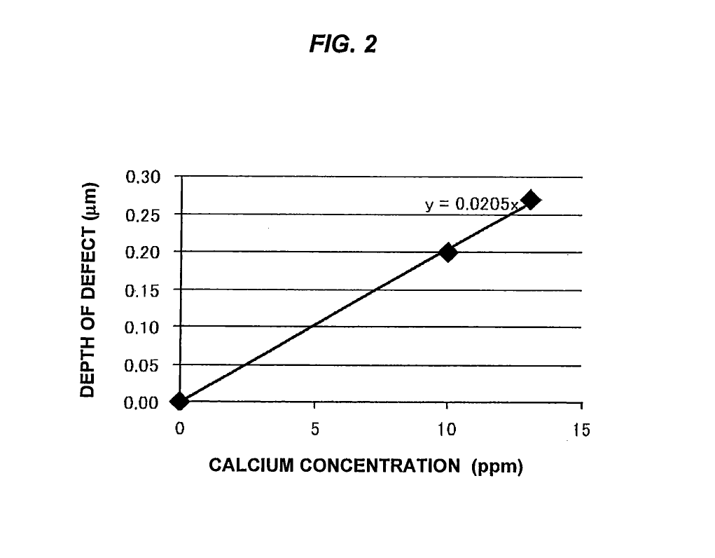

As a result of analyzing correlation between a depth of concave defect and a calcium concentration in a solution that is brought into contact with a glass before the preheating step, the present inventors have found that there is a proportional relation as shown in FIG. 2. The reason that the depth of concave defect and the calcium concentration in a solution that is brought into contact with a glass before the preheating step have a proportional relation is considered as follows.

The reason that the concave defects are generated on the surface of a glass substrate in a chemically strengthening step is that residual calcium on a glass surface becomes a barrier film of ion exchange by the preheating step, as described above. Depth of a path in which sodium ions and potassium ions are exchanged is typically from several tens to several hundreds μm. On the other hand, assuming that water droplets having a calcium concentration of about 10 ppm on a glass surface have a diameter of, for example, 5 mm, a thickness of a calcium barrier film after evaporation of water is less than 1 nm.

Therefore, since the thickness of the barrier film is sufficiently thin relative to the path in which potassium ions and sodium ions actually migrate, it can be considered that physical parameters relating to diffusion of ions remain unchanged, and it is considered that effective parameters are proportional only to the thickness of the calcium barrier film that is proportional to the calcium concentration.

As a result of investigations of the correlation between the depth of concave defect of a chemically strengthened glass substrate and appearance of the glass substrate, the present inventors have found that almost all of glass substrates having a depth of concave defect exceeding 200 nm has poor appearance, but when the depth of concave defect is 100 nm or less, the appearance is not damaged. This is considered because the depth of concave defect that can be visibly recognized by human eyes is about 100 nm or more that is ¼ of visible light (about 400 nm or more).

From the graph shown in FIG. 2, when the calcium concentration in a solution that is brought into contact with a glass before the preheating step is 5 ppm or less, the depth of concave defect can be decreased to approximately 100 nm or less. Therefore, to suppress generation of concave defects caused by the calcium ions, the calcium concentration contained in a cleaning liquid used in a final cleaning step before a chemical strengthening step needs to be 5 ppm or less.

In the production method of the present invention, the chemically strengthened glass can be produced by a conventional method, except that the calcium concentration contained in a cleaning liquid used in a final cleaning step before a chemical strengthening step is 5 ppm or less.

### [Method for Producing Glass Before Chemical Strengthening]

A glass that is to be subjected to chemical strengthening in the production method of the present invention can be produced by introducing predetermined glass raw materials in a continuous melting furnace, melting the glass raw materials preferably at from 1,500 to 1,600° C., clarifying the same, supplying the resulting molten glass to a molding apparatus, and molding the molten glass into a plate, followed by annealing. A composition of a glass produced by the production method of the present invention is not particularly limited.

Various methods can be employed in the molding of a glass substrate. For example, various molding methods such as a downdraw process (for example, an overflow downdraw process, a slot down process and a redraw process), a float process, a rollout process and a pressing process can be employed.

### [Polishing Step]

Polishing step is a step of polishing the glass substrate produced by the above production method with a polishing pad while supplying a polishing slurry. As the polishing slurry, a polishing slurry containing abrasive and water may be used. In the production method of the present invention, the polishing step is an optional step that is employed as necessary.

As the abrasive, cerium oxide (ceria) and silica are preferable. Incidentally, as mentioned above, when calcium is present on the surface of the glass substrate, it causes generation of concave defects by passing through preheating and ion exchange treatment, and therefore it is preferred that calcium is not contained in the abrasive.

### [Cleaning Step]

The cleaning step is a step of cleaning the glass substrate polished by the polishing step with a cleaning liquid. A neutral detergent and water is preferably used as the cleaning liquid, and it is more preferred that the glass substrate is cleaned with a neutral detergent and then cleaned with water. A commercially available neutral detergent may be used as the cleaning liquid.

Furthermore, as described above, the presence of calcium on the surface of the glass substrate causes generation of concave defects by passing through preheating and ion exchange treatment, and therefore it is preferred that calcium is not contained in the cleaning liquid used in the cleaning step.

### [Final Cleaning Step]

Final cleaning step is a step of cleaning the glass substrate cleaned by the cleaning step with a cleaning liquid. Examples of the cleaning liquid include water, ethanol and isopropanol. Of those, water is preferred. The calcium concentration in the cleaning liquid used in the final cleaning step is made 5 ppm or less. When the cleaning step is one step, the one step becomes the final cleaning step.

As a means for controlling the calcium concentration in the cleaning liquid used in the final cleaning step to be 5 ppm or less, there may be mentioned, for example, preventing incorporation of calcium in the cleaning liquid. Specifically, for example, because tap water contains calcium in a certain concentration, ion exchange water or distilled water is more preferably used. Furthermore, because human sweat contains calcium as a component as described above, it is preferred to prevent incorporation of calcium in the cleaning agent due to touching a glass substrate with bare hands.

Furthermore, it is preferred that the calcium concentration in the cleaning liquid used in the final cleaning step is periodically measured, and the cleaning liquid is exchanged such that the calcium concentration does not exceed 5 ppm. The calcium concentration in the cleaning liquid can be measured by a conventional method. Specifically, the calcium concentration can be measured by, for example, ICP plasma emission spectrometry.

### [Drying Step]

Drying step is a step of drying the glass substrate cleaned by the final cleaning step. The drying conditions may select the optimum conditions with taking the cleaning liquid used in the cleaning step, characteristics of a glass, and the like into consideration. In the production method of the present invention, the drying step is an optional step employed as necessary.

The chemical strengthening step includes the ion exchange step as the essential step, and in many cases, includes a preheating step before the ion exchange step.

### [Preheating Step]

The preheating step is a step of heating the glass substrate passed through the drying step to a preset preheating temperature. The preheating conditions may select optimum conditions with taking characteristics of a glass, a molten salt used in the ion exchange step, and the like into consideration. As specific conditions, for example, it is preferred that the preheating temperature is from 300 to 400° C. It is preferred that the preheating time is from 2 to 6 hours.

### [Ion Exchange Step]

The ion exchange step is a step of substituting an alkali metal ion having small ionic radius (for example, sodium ion) on the surface of a glass with an alkali metal ion having large ionic radius (for example, potassium ion). For example, the ion exchange step may be conducted by treating a glass containing sodium ion with a melt treatment salt containing potassium ion.

The ion exchange treatment can be conducted by, for example, dipping a glass plate in a potassium nitrate solution at from 400 to 550° C. for from 1 to 8 hours. The ion exchange conditions may select optimum conditions with taking viscosity characteristics of a glass, uses, plate thickness, tensile stress in a glass, and the like into consideration.

Examples of the molten salt for conducting the ion exchange treatment include alkali sulfates and alkali chlorides, such as potassium nitrate, sodium sulfate, potassium sulfate, sodium chloride and potassium chloride. Those molten salts may be used alone or as mixtures of two or more thereof.

In the present invention, the treatment conditions of the ion exchange treatment are not particularly limited, and optimum conditions may be selected with taking characteristics of a glass, molten salt, and the like into consideration.

Typically, the heating temperature of the molten salt is preferably 350° C. or higher, and more preferably 380° C. or higher. The heating temperature is preferably 500° C. or lower, and more preferably 480° C. or lower.

When the heating temperature of the molten salt is set to 350° C. or higher, the heat temperature prevents that the chemical strengthening becomes difficult to be effected by the decrease in ion exchange rate. When the heating temperature is 500° C. or lower, decomposition and deterioration of the molten salt can be suppressed.

Typically, the time that the glass substrate is brought into contact with the mixed molten salt is preferably 1 hour or more, and more preferably 2 hours or more, in order to give sufficient compression stress to the glass substrate. When the ion exchange is conducted for a long period of time, productivity is decreased and additionally, compression stress value is decreased by relaxation, and thus it is preferably 24 hours or less, and more preferably 20 hours or less.

### EXAMPLES

The present invention is described below by reference to Examples, but the invention is not construed as being limited thereto.

### Example 1

### Analysis of Depth of Concave Defect by Various Solutions

As a result of observation of a surface of a chemically strengthened glass substrate for display which has poor appearance, it was seen that the poor appearance is due to the generation of concave defects. Furthermore, as a result of measurement of a depth of concave defect, it was seen that the poor appearance is due to generation of concave defect having a depth exceeding 200 nm. It was further seen that when the depth of concave defect is generally 100 nm or less, the appearance does not become impaired. To examine the cause of the generation of concave defects, the depth of concave defect at a spot to which each of various solutions had been added dropwise was measured in the glass substrates.

20 μl of each of various solutions shown in Table 1 was added dropwise to a glass (composition (mol %): SiO₂: 64.5%, Al₂O₃: 6.0%, Na₂O: 12.0%, K₂O: 4.0%, MgO: 11.0%, CaO: 0.1% and ZrO₂: 2.5%). The glass was dried at 90° C. for 60 minutes, and preheated at 400° C. for 4 hours. The glass was then subjected to ion exchange treatment at 450° C. for 7 hours using KNO₃ as a molten salt to obtain a chemically strengthened glass.

The depth of concave defect in the chemically strengthened glass obtained was measured by combining an optical microscope and two beam interference objective lens CCD camera, vertically scanning an interference figure, and three-dimensionally measuring the surface shape of the object. The results are shown in Table 1.

TABLE 1

| Solution added dropwise | | Depth of concave defect (μm) |
|---|---|---|
| Ca(NO₃)₂ | 100 ppm | 0.7 |
| NaSiO₃ | 100 ppm | No defect |
| Tap water (Ca 13 ppm) | | 0.3 |
| Ion-exchanged water | | No defect |
| NaCl | 100 ppm | No defect |
| MgCl₂ | 100 ppm | No defect |
| FeCl₃ | 100 ppm | <0.01 |
| CeO₂ | 100 ppm | No defect |

As shown in Table 1, it was seen that when a solution containing calcium is brought into contact with a glass substrate, followed by preheating and ion exchange treatment, concave defect having a depth exceeding 200 nm is generated, and the appearance is impaired.

### Example 2

### Analysis of Concave Defect Generated by Dropwise Addition of Solution Containing Calcium and Composition of Glass Surface Near the Defect

20 μl of Ca(NO₃)₂ aqueous solution (100 ppm) was added dropwise to a glass substrate having the same composition as used in Example 1, preheating and ion exchange treatment were conducted under the same conditions as in Example 1, the composition of glass surface was observed with a scanning electron microscope, and concave defect part was analyzed by energy dispersive X-ray spectroscopy.

The Na content was 3 mass % in Na₂O conversion at the outer side of the concave defect, whereas the Na content was 10 mass % at the concave defect part. The K content was 20 mass % in K₂O conversion at the outer side of the concave defect, whereas the K content was 7 mass % at the concave defect part. The contents of Na and K at the concave defect part are close to the contents of Na₂O and K₂O of a glass before ion exchange. Furthermore, the content of Ca was 0.18 mass % in CaO conversion at the outer side of the concave defect, whereas the Ca content was 0.22 mass % at the concave defect part.

It was seen from this fact that, in the concave defect generated on a glass having been subjected to preheating and ion exchange treatment after the contact between a solution containing calcium and the glass, calcium salt is formed and the ion exchange between sodium ion and potassium ion is impaired due to the calcium salt.

### Example 3

### Analysis of Concave Defect Generated by Dropwise Addition of Solution Containing Calcium

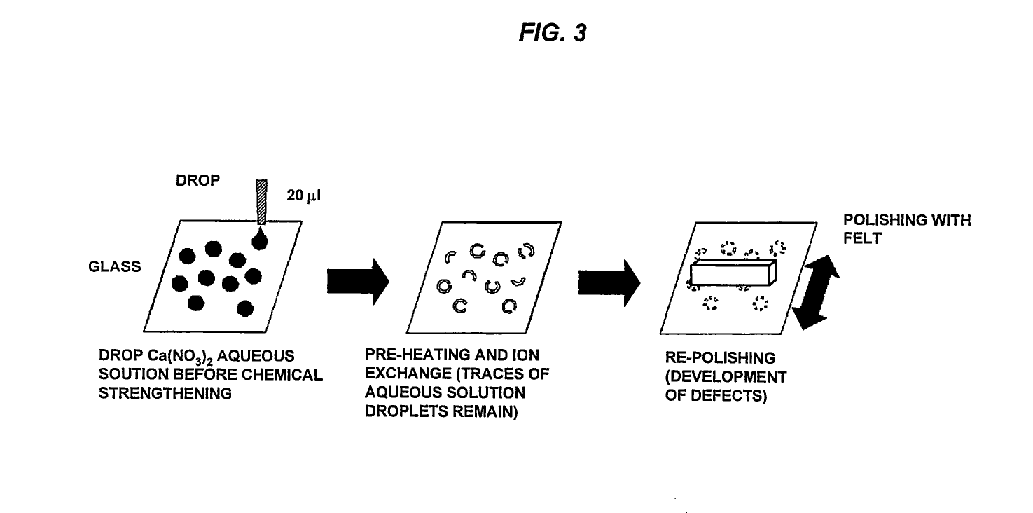

(1) 20 μl of 100 pm Ca(NO₃)₂ aqueous solution was added dropwise to a glass substrate having the same composition as that used in Example 1. The glass substrate was then subjected to preheating and ion exchange treatment under the same conditions as in Example 1, and was again polished with diamond abrasives having a diameter of 3 μm (FIG. 3). Thereafter, texture image of the concave defect generated at a site of the glass substrate to which Ca(NO₃)₂ aqueous solution had been added dropwise, and a depth and a width of the concave defect were analyzed.

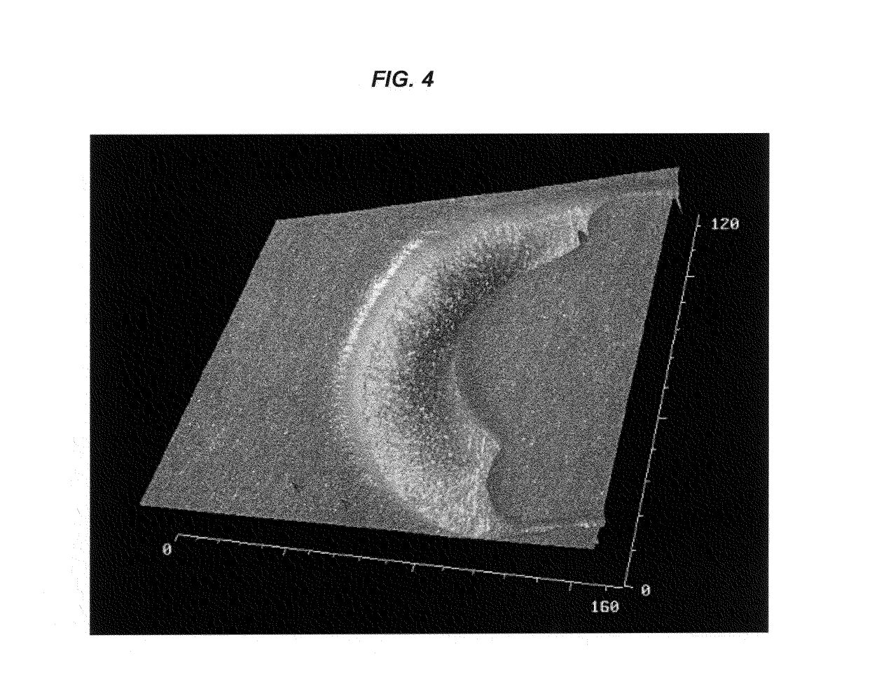

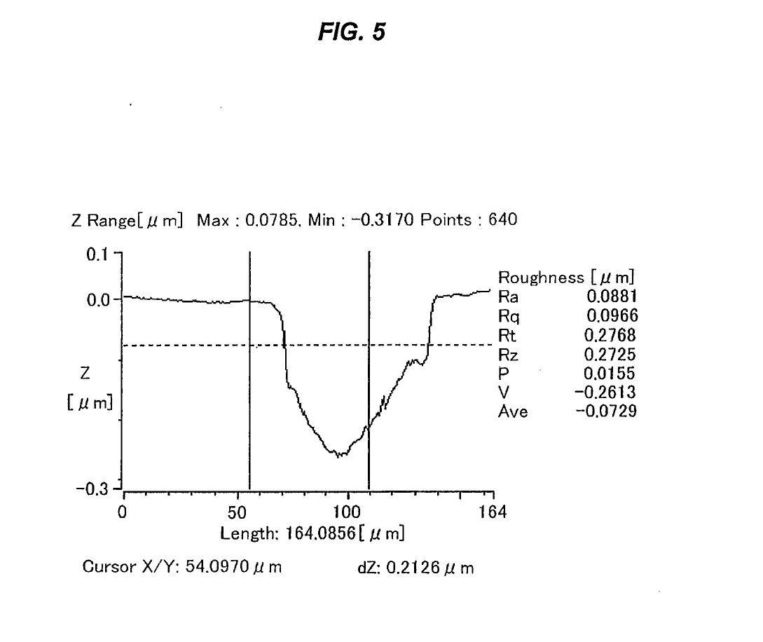

The texture image of the concave defect was analyzed by MM40 manufactured by Ryoka Systems Inc. The depth of the concave defect was measured by combining an optical microscope and two beam interference objective lens CCD camera, vertically scanning an interference image, and three-dimensionally measuring the surface shape of the object. The result of the texture image of the concave defect is shown in FIG. 4, and the depth and width of the concave defect are shown in FIG. 5.

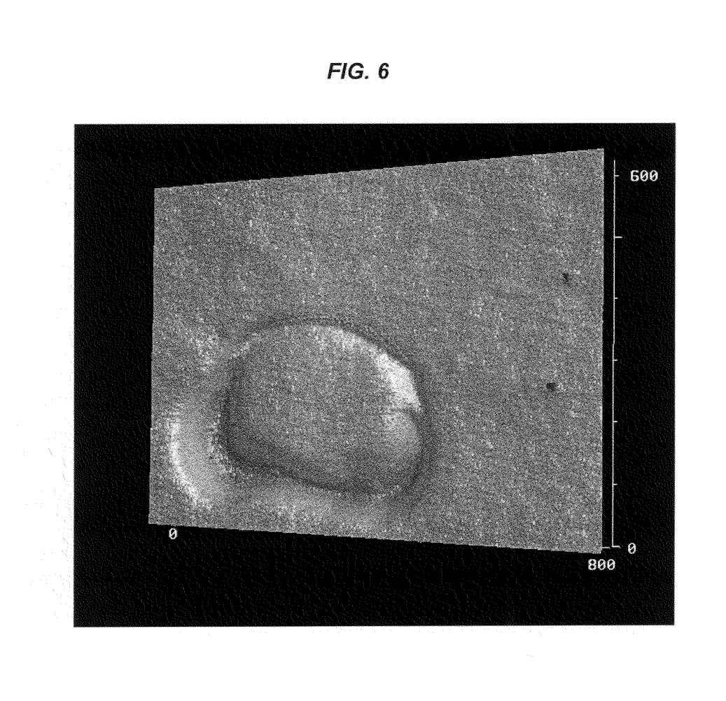

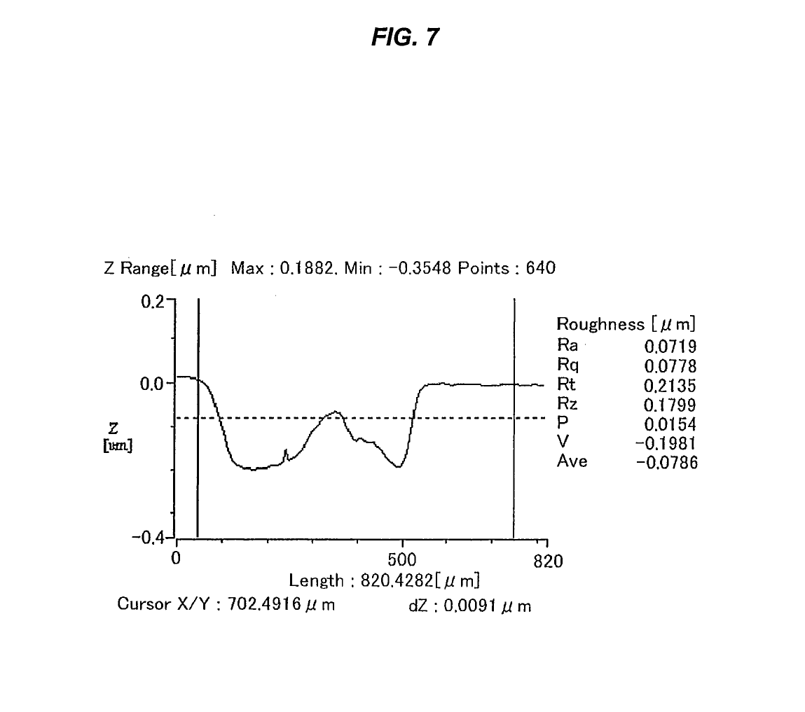

(2) 20 μl of an aqueous solution containing 100 ppm of Ca(NO₃)₂ was added dropwise to a glass substrate having the same composition as that used in Example 1. The glass substrate was then subjected to preheating and ion exchange treatment under the same conditions as in Example 1, and further subjected to ultrasonic cleaning for 5 minutes. Thereafter, an image of the concave defect generated at a site of the glass substrate to which Ca(NO₃)₂ aqueous solution had been added dropwise, and a depth and a width of the concave defect were analyzed in the same manner as in (1). The result of the texture image of the concave defect is shown in FIG. 6, and the depth and width of the concave defect are shown in FIG. 7.

As shown in FIGS. 4 to 7, concave defects were generated on the glass surface to which a solution containing calcium had been added dropwise. It was seen from this result that when a solution containing calcium is brought into contact with a glass surface and the glass is then passed through a preheating step and an ion exchange step, a concave defect is generated. Incidentally, the Ca content in the glass composition of the concave defect part is larger than that of other part.

### Example 4

### Correlation Between Depth of Concave Defect and Calcium Concentration

Similar to Example 3, 20 μl of an aqueous solution containing Ca(NO₃)₂ (calcium concentration: 10, 13 or 100 ppm) or ion-exchanged water was added dropwise to a glass substrate, and the glass substrate was then subjected to preheating and ion exchange treatment under the same conditions as in Example 1. The glass substrate was further rubbed with a polishing cloth impregnated with abrasives (diamond slurry having a diameter of 2 μm), and contamination attached to the glass surface was removed.

20 μl of ion-exchanged water containing no Ca(CO₃)₂ (calcium concentration: 0 ppm) was added dropwise to each of 13 sheets of glass substrates, and the glass substrates were subjected to preheating and ion exchange treatment under the same conditions as in Example 1. The glass substrates were further rubbed with a polishing cloth impregnated with abrasives (diamond slurry having a diameter of 2 μm), and contamination attached to the glass surface was removed, followed by visual observation. As a result, concave defect was not recognized by visual observation.

The depth of concave defect on the glass substrate was measured in the same manner as in Example 1, and the results are shown in Table 2. A graph in which the depths of the concave defects when the calcium concentration was 0, 10 or 13 ppm were plotted and an approximated is shown in FIG. 2.

TABLE 2

| Calcium concentration (ppm) | Depth of concave defect (μm) |
|---|---|
| 0 | 0.00 |
| 10 | 0.20 |
| 13 | 0.27 |
| 100 | 0.74 |

As a result, as shown in FIG. 2, it was seen that the calcium concentration (x) contained in a solution that is brought into contact with the glass substrate before preheating and ion exchange treatment and the depth (y) of the concave defect have the proportional relation (y=0.0205x), and there is a correlation between those. It was further seen from the graph of FIG. 2 that when the calcium concentration is 5 ppm or less, the depth of the concave defect is generally 100 nm or less, and the appearance is not impaired.

In fact, similar to Example 3, one of two kinds of aqueous solutions containing Ca(NO₃)₂ (calcium concentration: 1 ppm or 5 ppm) or ion-exchanged water was added dropwise to respective five glass substrates, the glass substrates were then subjected to preheating and ion exchange treatment under the same conditions as in Example 1 and further rubbed with a polishing cloth impregnated with abrasives (diamond slurry having a diameter of 2 μm) to remove contamination attached to the glass surface, and glass surface was observed. As a result, concave defect was not visually observed in all of the glass substrates.

The reason that the calcium concentration (x) and the depth (y) of the concave defect have the proportional relation is considered that because the thickness of a barrier film with respect to ion exchange by calcium is sufficiently thin relative to a path in which potassium ions and sodium ions actually migrate as described before, it is assumed that physical parameters relating to diffusion of ions remain unchanged, and effective parameters are proportional only to the thickness of the barrier film that is proportional to the calcium concentration.

### Reference Example

Analysis of Glass Composition on Surface of Concave Defect Generated on Glass Surface by Preheating and Ion Exchange Treatment after Dropwise Addition of Solution Containing Calcium

10 ml of an aqueous solution containing 100 ppm of CaCl₂ was added dropwise to a glass substrate having the same glass composition as in Example 1, and the glass substrate was dried at 90° C. for 60 minutes and then preheated at 450° C. for 3 hours. The glass substrate was then subjected to ion exchange treatment at 450° C. for 7 hours using KNO₃ as a molten salt, whereby a chemically strengthened glass was obtained.

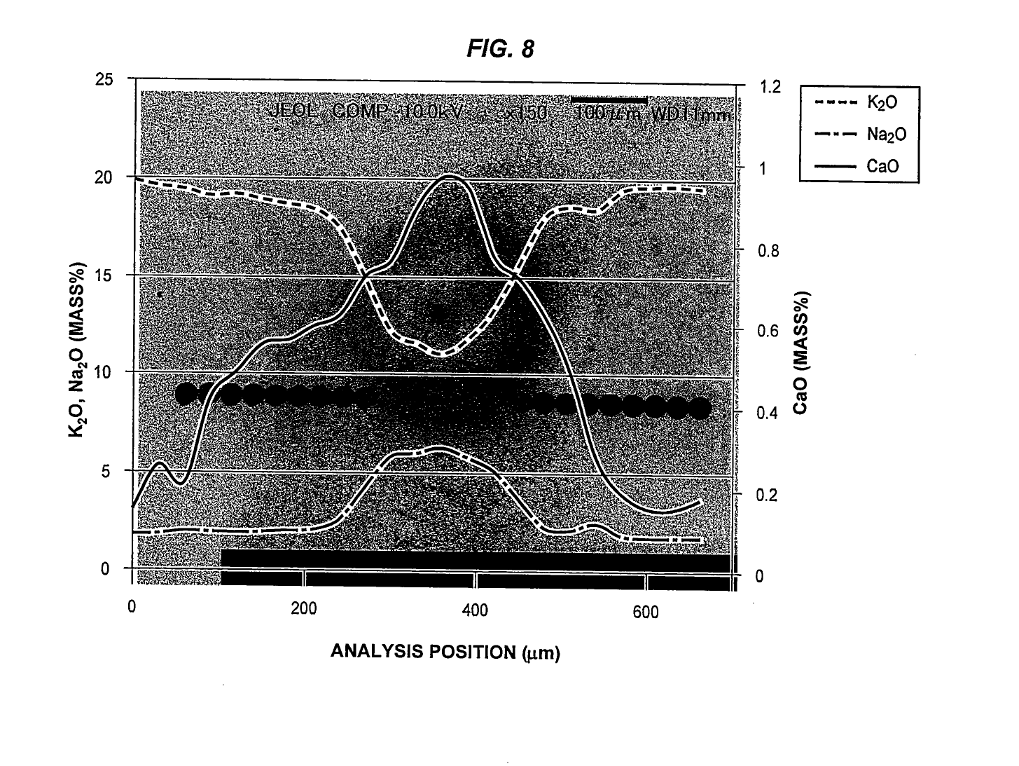

A concave defect was generated on the chemically strengthened glass obtained, and contents (unit: mass %) of K₂O, Na₂O and CaO at the defect part and at the portion near the defect were measured by energy dispersive X-ray spectroscopy. The results are shown in FIG. 8.

The central halo part in FIG. 8 is a concave defect part. Dots continuing into right and left at slight lower center in FIG. 8 are analysis traces.

The vertical axis (right) in FIG. 8 shows the contents of K₂O and Na₂O in the glass composition, and the vertical axis (right) therein shows the content (mass %) of CaO in the glass composition. The horizontal axis in FIG. 8 shows an analysis position (μm) from the left end, and a length of upper right black scale in FIG. 8 is 100 μm.

As shown in FIG. 8, the contents of K₂O, Na₂O and CaO were from 18 to 20 mass %, 2 mass % and from 0.2 to 0.6 mass %, respectively, at a part near the concave defect, and were from 11 to 18 mass %, from 3 to 6 mass % and from 0.6 to 1 mass %, respectively, at the defect part.

This result shows that a calcium salt is formed in the concave defect generated on a glass having been subjected to preheating and ion exchange treatment after the contact between a solution containing calcium and the glass, and ion exchange between sodium ions and potassium ions is impaired.

While the present invention has been described in detail and with reference to specific embodiments thereof, it will be apparent to one skilled in the art that various changes and modifications can be made therein without departing from the scope thereof. This application is based on Japanese patent application No. 2010-270395 filed Dec. 3, 2010, the entire contents thereof being hereby incorporated by reference.

1. A method for producing a chemically strengthened glass substrate for a display device, wherein a calcium concentration in a cleaning liquid used in a final cleaning step before a chemical strengthening step is 5 ppm or less.

2. The method for producing a chemically strengthened glass substrate for a display device according to claim 1, wherein the cleaning liquid is water.
